(19) United States
(12) Patent Application Publication
(10) Pub. No.: US 2026/0078627 A1
(43) Pub. Date: Mar. 19, 2026

(54) DOOR THRESHOLD WITH A COLD-BRIDGING BREAK

(71) Applicant: Enerest OÜ, Harju Maakond (EE)

(72) Inventor: Siim Rannik, Harju Maakond (EE)

(73) Assignee: Enerest OÜ, Harju Maakond (EE)

(21) Appl. No.: 19/319,805

(22) Filed: Sep. 5, 2025

(30) Foreign Application Priority Data
Sep. 18, 2024 (EE) 202400028

(51) Int. Cl. E06B 1/70

(52) U.S. Cl. CPC E06B 1/70; E06B 2001/707

(57) ABSTRACT

The invention relates to a door threshold with a cold-bridging break, which includes cast floor plates 1 and 2 that are on opposite sides of the door threshold, and reinforcement bars 3 connecting them. Between the floor plates 1 and 2, there is a vertical thermal insulation plate 4 with an edge running in the direction of the door threshold, the upper edge of the vertical thermal insulation plate 4 is covered by a generally U-shaped door threshold cover profile 5. Reinforcement bars 3 are made of non-metallic material, vertical thermal insulation plate 4 is a cellular glass plate, and U-shaped cover profile 5 is made of thermoplastic elastomer (TPE).

### CROSS REFERENCE TO RELATED APPLICATIONS

The present application claims priority from EE U202400028 filed on Sep. 18, 2024. The content of this application is hereby incorporated herein by reference in its entirety.

### TECHNICAL FIELD

The invention relates to a door threshold, more specifically a door threshold with a cold-bridging break, that is with a thermal break. In particular, the invention relates to a door threshold for use in the openings of home or industrial garage doors, doorways, automatically opening door bases with a slab or strip foundation, where there is frequent movement of people or machinery in and out of the building.

### BACKGROUND ART

A door threshold design for breaking a cold-bridging is known from the US patent application US2021/172240A1 (published 10 Jun. 2021). The concrete slab outside the building and the concrete slab of the floor inside the building are connected to each other by steel reinforcement bars perpendicular to the direction of the door threshold, which ensures the stability of these concrete slabs against differential settlement, and a thermal insulation plate is located between these concrete slabs. The thermal insulation plate is covered with a cover profile, which is a metal profile with a U-shaped cross-section running along the threshold, the edges of which rest on the steel reinforcement.

This U-shaped metal profile passes through the insulated vertical line and, together with the steel reinforcement, further reduces the heat retention of the design. The top surface of the U-shaped metal profile is smooth and flush with the floor, so in the event of an unfavourable wind direction, for example, rainwater will be pushed by the wind through the door seal into the interior. The insulation used in this solution is EPS thermal insulation plates. EPS thermal insulation plates are exposed to conditions influenced by water and water vapor, which over time penetrate into the thermal insulation plates and which over the years will result in the moisture content of the EPS thermal insulation boards rising to 10% by volume, reducing heat retention by a factor of approximately 3.

From Finnish patent FI128868B (published 3 Aug. 2017), a door threshold is known comprising an elongated plate-like housing forming a door threshold cover profile, which is generally U-shaped and wherein the lower surface of the housing has gripping elements for coupling to a concrete slab outside the building and to a concrete slab of the floor inside the building. A thermal insulation plate is fixed to the underside of the housing to prevent the formation of a cold-bridging. A heating element, such as a heating cable, heating mat, etc., is placed between the thermal insulation plate and the U-shaped housing.

Such design of the housing does not prevent the differential settling of the interior and exterior floor (concrete slabs). Due to its high specific thermal conductivity, the metal housing is an element which, in the solution, counteracts breaking the cold-bridging and requires separate heating as a heating element to prevent condensation.

The earlier solutions described above have tried to avoid the formation of a cold-bridging in the door threshold, but the choice of materials used in these solutions poses problems in long-term use. Steel components of the design pass through the thermal break area, thermal insulation materials are not resistant to water vapor diffusion, etc.

The aim of the invention is to provide a door threshold with a cold-bridging break that overcomes the drawbacks of the prior art, is easy to install, and maintains a virtually unchanged thermal insulation performance throughout its service life.

### SUMMARY OF INVENTION

The present invention provides a door threshold with a cold-bridging break comprising cast floor plates on the opposite sides of the door threshold and reinforcements bars connecting them, a vertical thermal insulation plate with an edge running in the direction of the door threshold between the floor plates, and a generally U-shaped door threshold cover profile covering the upper edge of the thermal insulation plate.

The reinforcement bars are made of a non-metallic material, such as fiberglass composite. The reinforcement bars are made of a non-metallic material with a specific thermal conductivity (λ) of less than 0.7 W/(m·K).

The thermal insulation plate is a cellular glass insulation plate with a thickness of at least 40 mm, preferably at least 50 mm. The U-shaped cover profile is made of thermoplastic elastomer (TPE). The cellular glass thermal insulation plate has a minimum compressive strength of 2.9 MPa.

In another embodiment, there is a horizontal cellular glass thermal insulation plate under at least one of the cast floor plates, the edge of which rests against a vertical thermal insulation plate between the floor plates. The cellular glass thermal insulation plate has a thickness of at least 40 mm, preferably at least 50 mm.

### BRIEF DESCRIPTION OF DRAWINGS

The invention is described below with reference to the accompanying schematic drawings, where:

FIG. 1 shows a sectional axonometric view of the design of a door threshold with a cold-bridging break according to the invention;

FIG. 2 shows the door threshold design according to FIG. 1 in a section perpendicular to the door threshold;

FIG. 3 shows an axonometric view of the design elements of the door threshold depicted in FIGS. 2 and 3; and

FIGS. 4 and 5 show two embodiments of the door threshold cover profile.

### EXAMPLE OF AN EMBODIMENT

For the sake of clarity, the same details and elements in different figures are marked with the same reference numbers.

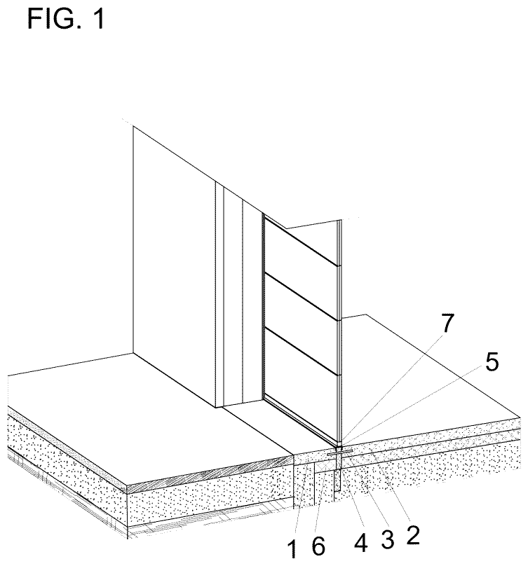

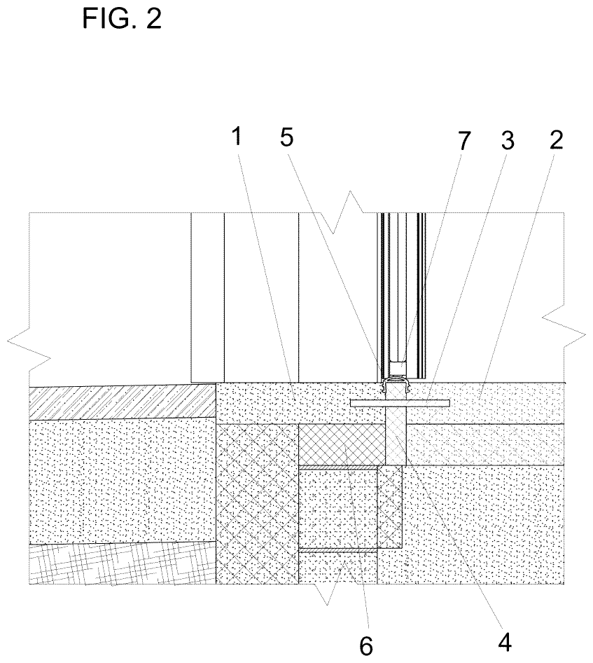

FIGS. 1 and 2 show a door threshold with a cold-bridging break according to the invention, comprising concrete cast floor plates 1 and 2 on the opposite sides of the door threshold. The reinforcement bars 3 that connect them pass between the floor plates 1 and 2 through the vertical thermal insulation plate 4 with an edge running in the direction of the door threshold.

The upper edge of the vertical thermal insulation plate 4 is generally covered by a U-shaped door threshold cover profile 5. In the embodiment according to the figures, there is a horizontal cellular glass thermal insulation plate 6 under one of the cast floor plates 1, the edge of which rests against a vertical thermal insulation plate 4 between the floor plates.

In the embodiment shown in the figures, the lower edge of the vertical thermal insulation plate 4 is supported by the XPS thermal insulation plate.

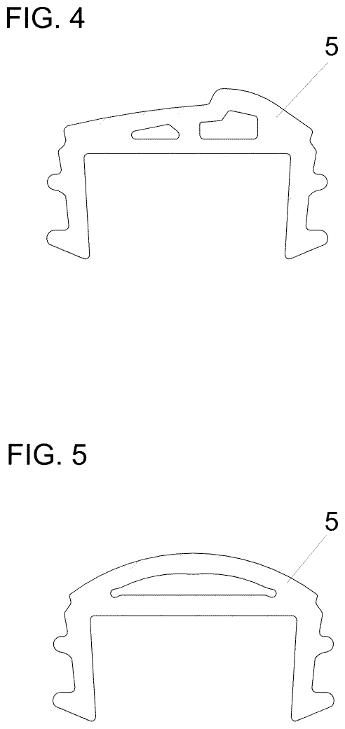

The example embodiment in FIGS. 1 and 2 shows a garage door 7 with its lower edge resting against the door threshold cover profile 5 in the closed position. Two possible embodiments of the cross-section of the cover profile 5 are shown in FIGS. 4 and 5.

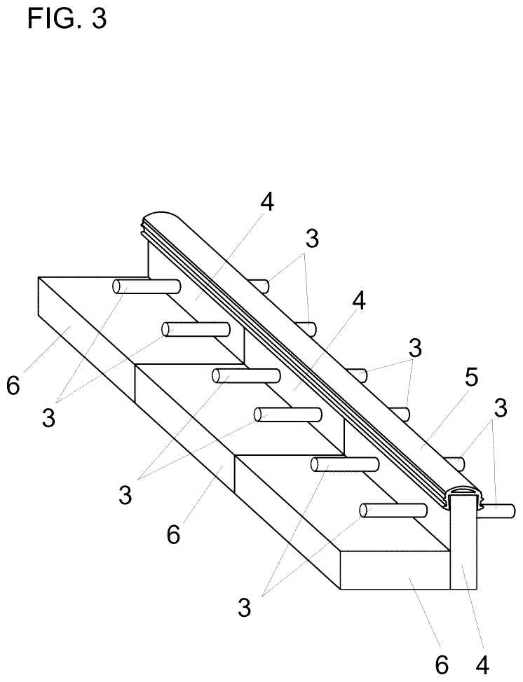

For the sake of clarity, the design elements of the door threshold without floor plates 1 and 2 and the rest of the building design are shown in FIG. 3. The illustrated horizontal cellular glass thermal insulation plate 6 may be on either side of the vertical thermal insulation plate 4 or the door threshold design may be without a thermal insulation plate 6.

The reinforcement bars 3 are made of non-metallic material, whereas the vertical thermal insulation plate 4 and the horizontal cellular glass thermal insulation plate 6 are made of cellular glass plate. An example of a cellular glass thermal insulation plate 6 is Foamglas T3+ with a thickness of 100 mm.

An example of a vertical thermal insulation plate 4 is the Perinsul HL cellular glass plate 50 ×200 ×450 mm.

Examples of the reinforcement bars 3 are Schöck Isolink C-SH-D12-L 350/200-30°-1.0 fiberglass anchors. Schöck Isolink anchors are 70 times less thermally conductive than steel reinforcement bars and 25 times less thermally conductive than stainless steel reinforcement bars.

Thanks to the C-SH-D12 anchor's local thermal conductivity of 0.0009 W/(m·K), heat loss is practically zero. An average of 4.44 anchors per meter is used, the thermal conductivity correction factor for a 3-meter-wide doorway is 0.01 W/(m·K).

The U-shaped cover profile 5 is made of thermoplastic elastomer (TPE), a highly UV-resistant, highly elastic strong material. The shape of the cover profile 5 is such that in a free state the highest point is 12 mm above the floor level.

As a result, rainwater is prevented from entering the interior under the garage door seal by wind. There is a gap of 6 mm in the horizontal part of the U-profile, under the vehicle wheel the profile is 7 mm above the floor.

The U-shape of the cover profile 5 prevents water, dirt, debris, leaves, and snow from getting from one side of the cover profile 5 to the other (from the outside to the inside and vice versa) and facilitates tight sealing of the seal at the bottom of the lowered garage door 7 against said cover profile 5.

The thermal expansion of a cellular glass plate is similar to concrete, and the lifespan of cellular glass is also similar to concrete floors. The heat retention of a cellular glass plate is not affected by water or moisture.

For example, the specific thermal conductivity (λ) of the Perinsul HL cellular glass is 0.058 W/(m·K) and does not change over time. The compressive strength at 0% deformation is 2.9 MPa, sufficient to withstand the loads exerted by the vehicle wheels.

For example, Foamglas T3+ cellular glass plate has a specific thermal conductivity (λ) of 0.036 W/(m·K and a compressive strength of 500 kPa at 0% deformation.

### LIST OF REFERENCE NUMBERS

1 floor plate
2 floor plate
3 reinforcement bar
4 vertical thermal insulation plate
5 cover profile
6 horizontal thermal insulation plate
7 garage door

1. A door threshold with a cold-bridging break comprising cast floor plates (1, 2) on the opposite sides of the door threshold and reinforcements bars (3) connecting them, a vertical thermal insulation plate (4) with an edge running in the direction of the door threshold between the floor plates (1, 2), a generally U-shaped door threshold cover profile (5) covering the upper edge of the vertical thermal insulation plate (4), characterised in that
the reinforcement bars (3) are made of a non-metallic material,
the vertical thermal insulation plate (4) is a cellular glass board, and
the U-shaped cover profile (5) is made of thermoplastic elastomer (TPE).

2. The door threshold with a cold-bridging break according to claim 1, characterised in that the reinforcement bars (3) are made of fiberglass composite.

3. The door threshold with a cold-bridging break according to claim 1, characterised in that the reinforcement bars (3) are made of a non-metallic material having a specific thermal conductivity (λ) less than 0.7 W/(m·K).

4. The door threshold with a cold-bridging break according to claim 1, characterised in that the cellular glass plate has a minimum compressive strength of 2.9 MPa.

5. The door threshold with a cold-bridging break according to claim 1, characterised in that the cellular glass plate is at least 50 mm thick.

6. The door threshold with a cold-bridging break according to claim 1, characterised in that the reinforcement bars pass through a vertical thermal insulation plate (4).

7. The door threshold with a cold-bridging break according to claim 1, characterised in that under at least one of the cast floor plates (1, 2) there is a horizontal cellular glass thermal insulation plate (6), the edge of which rests against a vertical thermal insulation plate (4) between the floor plates (1, 2).
